(19) United States
(12) Patent Application Publication
(10) Pub. No.: US 2004/0175582 A1
(43) Pub. Date: Sep. 9, 2004

(54) Laser ablation resistant copper foil

(75) Inventors: William L. Brenneman, Cheshire, CT (US); Szuchain F. Chen, Hamden, CT (US); Harvey P. Cheskis, North Haven, CT (US)

Correspondence Address: WIGGIN AND DANA LLP, ATTENTION: PATENT DOCKETING, ONE CENTURY TOWER, P.O. BOX 1832, NEW HAVEN, CT, 06508-1832, US

(73) Assignee: Olin Corporation, a corporation of the Commonwealth of Virginia

(21) Appl. No.: 10/801,213

(22) Filed: Mar. 15, 2004

Related U.S. Application Data
(63) Continuation-in-part of application No. 10/777,940, filed on Feb. 11, 2004.
Application No. 10/777,940 is a continuation-in-part of application No. 10/727,920, filed on Dec. 4, 2003.
(60) Provisional application No. 60/431,013, filed on Dec. 5, 2002.

(51) Int. Cl. B32B 15/04; B32B 15/08

(52) U.S. Cl. 428/457; 428/607; 428/687; 428/469; 428/472

(57) ABSTRACT

A copper foil for lamination to a dielectric substrate is coated with a laser ablation inhibiting layer having an average surface roughness (R_{z}) of less than 1.0 micron and an average nodule height of less than 1.2 micron that is effective to provide a lamination peel strength to FR-4 of at least 4.5 pounds per inch. The coated foil further has a reflectivity value of at least 40. The coated foil is typically laminated to a dielectric substrate, such as glass reinforced epoxy or polyimide and imaged into a plurality of circuit traces. Blind vias may be drilled through the dielectric terminating at an interface between the foil and the dielectric. The coated foil of the invention resists laser ablation, thereby resisting piercing of the foil by the laser during drilling.

### CROSS REFERENCE TO RELATED APPLICATIONS

This patent application is a continuation in part of U.S. patent application Ser. No. 10/777,940 entitled “Laser Ablation Resistant Copper Foil,” that was filed on Feb. 11, 2004 which is a continuation in part of U.S. patent application Ser. No. 10/727,920, entitled “Peel Strength Enhancement of Copper Laminates,” that was filed on Dec. 4, 2003 and in turn claims the benefit of U.S. Provisional Patent Application No. 60/431,013 that was filed on Dec. 5, 2002. All three of the Ser. Nos. 10/777,940; 10/727,920 and No. 60/431,013 patent applications are incorporated by reference herein in their entireties.

### BACKGROUND OF THE INVENTION

1. Field of the Invention

This invention relates to the manufacture of printed circuit boards having a copper foil layer laminated to a dielectric substrate, and more particularly to a treatment to increase the adhesion of the copper foil layer to the dielectric substrate.

2. Description of the Related Art

Copper and copper base alloy foils are widely used in the printed circuit board industry. The foil is produced to a thickness of under 203 microns (0.008 inch) and more generally to a thickness in the range of from 5.1 microns (0.0002 inch that is known in the art as 1/7 ounce foil) to 1.0 micron (0.00004 inch). The foil is typically produced by either mechanical working or electrodeposition. “Wrought” foil is produced by mechanically reducing the thickness of a copper or copper alloy strip by a process such as rolling. “Electrodeposited” foil is produced by electrolytically depositing copper ions on a rotating cathode drum and then peeling the deposited strip from the cathode.

The copper foil is bonded to a dielectric substrate forming a printed circuit board using a lamination process. The dielectric substrate is typically a fiberglass reinforced epoxy such as FR-4 (a fire retardant epoxy) or a polyimide such as Kapton® manufactured by DuPont. The lamination process includes bonding the copper foil layer to the dielectric substrate through the use of heat and pressure. For FR-4, a pressure of about 300 pounds per square inch (psi), at a temperature of about 180° C. for a time of approximately 30 minutes will provide suitable adhesion between the layers. Polyimide is typically laminated at a pressure of 425 psi and a temperature of 300° C. for 2 minutes.

To maximize adhesion, it is often desirable to roughen the surface of the foil that contacts the dielectric substrate prior to bonding. While there are a variety of techniques available to roughen or treat the foil, one exemplary technique involves the formation of a plurality of copper or copper oxide dendrites on the foil surface. U.S. Pat. Nos. 4,468,293 and 4,515,671, both to Polan et al. disclose this treatment. This treatment is referred as the CopperBond® treatment. CopperBond is a trademark of Olin Corporation of Norwalk, Conn. Another electrolytic surface roughening treatment is the deposition of copper/nickel nodules onto the surface of the foil that contacts the dielectric substrate, as disclosed in U.S. Pat. No. 5,800,930 to Chen et al. In some instances, at least one side of the foil, particularly the roughened side bearing the dendrites, may have an electrodeposited coating of zinc or brass applied thereto. This coating has been found to enhance the bond strength of the foil with the dielectric substrate.

While the use of roughened surfaces on the copper foil is effective to promote adhesion with the dielectric substrate, the degree of surface roughening is often restricted by the electrical performance requirements of the copper foil for high frequency applications. Problematically, decreasing the surface roughness to meet these electrical performance requirements compromises the adhesion (peel strength) between the copper foil and the dielectric substrate.

Another problem facing printed circuit board manufacturers using either electrolytic or wrought copper foils is the relative reactivity of the copper. As a result, copper readily stains and tarnishes. The stains and tarnish are aesthetically unpleasant and may be a source of problems during the manufacture of the printed circuit board. For example, staining of copper foil prior to lamination can affect both the bond strength between the foil and the dielectric substrate and the etching characteristics of the resultant laminate. The tarnish resistance of a copper foil may be enhanced by applying a thin (can be on the atomic scale) coating that contains co-deposited ions of zinc and chromium. This treatment, referred to as the P2 treatment, is disclosed in U.S. Pat. No. 5,022,968 to Lin et al.

The U.S. Pat. Nos. 4,515,671; 5,800,930 and 5,022,968 patents are incorporated by reference in their entireties herein.

When copper foil is laminated to a dielectric substrate it is usually then selectively etched to form a plurality of circuit traces. Frequently, copper foil is laminated to both sides of the dielectric substrate and both sides selectively etched into circuit traces. It is often desired to electrically interconnect circuit traces on opposing sides of the dielectric. Electrical interconnection may be done by drilling a hole through the dielectric and depositing an electrically conductive material in the hole to form a conductive via. A blind via extends from one side of the dielectric to the interface of the dielectric and the copper foil on the second side of the dielectric. The most accurate blind vias are formed by laser ablation of the dielectric, such as with a carbon dioxide, CO₂, laser. However, it is difficult to stop the laser at the interface and avoid ablation of the copper transforming the desired blind via into a through hole via.

There remains a need for a treatment for copper foil that provides an enhanced combination of improved adhesion to a dielectric, tarnish resistance and laser ablation resistance.

### BRIEF SUMMARY OF THE INVENTION

In one aspect of the invention, a peel strength enhancement coating is deposited on a surface of a copper foil, which may be laminated to a dielectric substrate. The peel strength enhancement coating consists essentially of a metal and metal oxide mixture, the metal and metal oxide mixture being formed from one or more of: vanadium, niobium, tantalum, chromium, molybdenum, tungsten, manganese, technetium, and rhenium. Preferably, the metal oxide is selected from one of chromate, tungstate, and molybdate. The surface of the copper foil may be smooth, and the peel strength enhancement coating may have a thickness of between about 20 to about 200 angstroms. Silane may be deposited on the peel strength enhancement coating prior to lamination to the dielectric substrate.

In another aspect of the invention, an article comprises a copper foil having a smooth surface laminated to a dielectric substrate. A peel strength enhancement coating is disposed between the copper foil and the dielectric substrate, and the copper foil exhibits less than or equal to 10% loss of peel strength when measured in accordance with IPC-TM-650 Method 2.4.8.5 using a 1/8 inch test specimen after being immersed in 4N HCl at 60° C. for 6 hours. The peel strength enhancement coating may also exhibit less than or equal to 10% edge undercut after the immersion in 4N HCl at 60° C. for 6 hours.

In another aspect of the invention, a method for increasing the peel strength of a copper foil laminated to a dielectric substrate comprises: prior to lamination, immersing the copper foil in an aqueous electrolytic solution containing oxyanions formed from one or more of: vanadium, niobium, tantalum, chromium, molybdenum, tungsten, manganese, technetium, and rhenium. Preferably, the metal is selected from one of chromium, molybdenum, and tungsten. The aqueous solution may be an electrolyte solution in an electrolytic cell, and the method further comprises: passing current through the copper foil and the electrolyte solution such that a coating having a thickness of between about 20 to about 200 angstroms is deposited on the copper foil. The method may further comprise immersing the copper foil in silane after depositing the coating on the copper foil.

In another aspect of the invention, a copper foil for lamination to a dielectric substrate comprises a layer deposited on a surface of the copper foil. The layer is formed from chromium and zinc ions or oxides and is treated with an aqueous solution containing at least 0.5% silane. The surface of the copper foil may be smooth, and the thickness of the layer may be from about 10 angstroms to about 100 angstroms.

In another aspect of the invention, a method for increasing the peel strength of a copper foil laminated to a dielectric substrate comprises: prior to lamination, co-depositing a mixture of chromium and zinc ions or oxides on surfaces of the copper or copper base alloy foil; subsequent to the co-deposition step, immersing the copper foil for at least one second in an aqueous solution containing at least 0.5% silane in deionized water; and drying the copper foil prior to lamination. The aqueous solution may be at a temperature of between about 15° C. to about 30° C. Co-depositing the mixture of chromium and zinc ions or oxides may include: providing an electrolytic cell containing an anode disposed in an electrolyte solution containing chromium and zinc ions; providing the copper foil as a cathode; and electrolytically depositing the chromium and zinc ions on the copper foil. The thickness of a layer formed from the chromium and zinc ions or oxides may be from about 10 angstroms to about 100 angstroms.

In one embodiment, the electrolyte solution is a basic solution containing hydroxide ions from about 0.07 g/l to about 7 g/l zinc ions, and from about 0.1 g/l to about 100 g/l of a water soluble hexavalent chromium salt wherein the concentration of either the zinc ions or the chromium (VI) ions or both is less than 1.0. In this embodiment, the co-deposition step includes: immersing the copper foil in the electrolyte solution; and passing current through the copper foil and the electrolyte solution such that a current density of from about 1 milliamp per square centimeter to about 1 amp per square centimeter is provided. The electrolyte solution may consist essentially of from about 10 to about 35 g/l NaOH, from about 0.2 to about 2.5 g/l ZnO, and from about 0.2 to about 2 g/l Na₂Cr₂O_{70.2}H₂O.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

The invention will be more fully understood from the following detailed description taken in conjunction with the accompanying drawings wherein like elements are numbered alike, and in which:

FIG. 1 illustrates an electrolytic cell system for peel strength enhancement of a copper laminate according to one embodiment of the present invention;

FIG. 2 illustrates an electrolytic cell system for peel strength enhancement of a copper laminate according to another embodiment of the present invention;

FIG. 3a is a cross-sectional view of a copper foil laminated to a dielectric substrate before exposure to hydrochloric acid (HCl);

FIG. 3b is a cross-sectional view of a copper foil laminated to a dielectric substrate after exposure to HCl;

FIG. 3c is a lengthwise view of the copper foil of FIG. 3b revealing an undercut coating; and

FIG. 4 is a graph depicting percent peel strength loss as a function of percent undercut.

FIG. 5 illustrates in cross-sectional representation laser ablation to form a blind via.

FIG. 6 is a photomicrograph illustrating the surface morphology of a surface treatment as known from the prior art.

FIG. 7 is a photomicrograph illustrating the surface morphology of a surface treatment of the invention.

FIG. 8 schematically illustrates a method to determine the reflectivity value.

FIG. 9 graphically illustrates a correlation between nodule height and reflectivity value.

### DETAILED DESCRIPTION

Two surface treatments are described herein that generate high adhesion between copper foil and a dielectric substrate, even where smooth copper foil is used. The invention is equally applicable to copper or copper-base alloy foils, where “base” means that the alloy contains at least 50%, by weight, of copper. As used herein, the term “copper foil” includes copper foil and copper-base alloy foil. Also, while the invention is particularly useful for use with a smooth copper foil, the invention could be applied to copper foils having any surface finish. The term “smooth”, as used herein means a low profile surface, e.g., less than 1 μm Rz, where Rz is the average of five peak to valley distance measurements as measured using a surface profilometer.

Surface Treatment 1

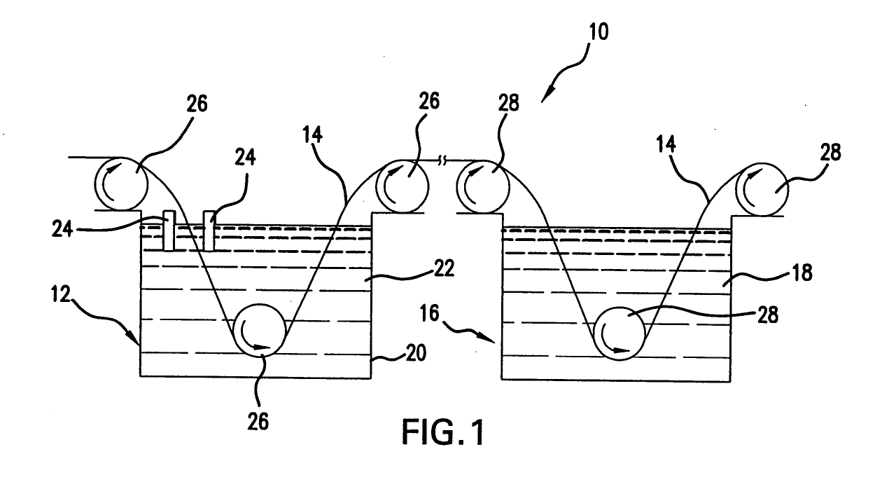

FIG. 1 illustrates a system 10 for peel strength enhancement of a copper laminate according to a first aspect of the present invention. The system 10 includes an electrolytic cell 12 for co-depositing a mixture of chromium and zinc metals or oxides on surfaces of a copper foil 14 using what is referred to herein as a P2 treatment, and a silane solution tank 16 wherein the coated copper foil 14 is immersed in an aqueous solution 18 containing silane. After leaving the silane solution tank 16, the copper foil 14 may be rinsed using deionized (DI) water and then dried before it is laminated to a dielectric substrate.

The electrolytic cell 12 includes a tank 20 containing an electrolytic solution 22, and anodes 24 between which the strip of copper foil 14 passes. The silane solution tank 16 contains the aqueous solution 18 containing silane. Guide rolls 26 and 28 may be used to control the travel of the strip of copper foil 14 through the electrolytic cell 12 and the silane solution tank 16, respectively. The guide rolls 26 and 28 are manufactured from any material that does not react with electrolyte solution 22. Preferably, at least one of the guide rolls 26 is formed from an electrically conductive material, such as stainless steel, so that a current may be impressed in the strip of copper foil 14 as detailed below. Guide rolls 26 rotate at a controlled speed so that the copper foil 14 is positioned between anodes 24 for a required time as discussed below. Guide rolls 28 rotate at a controlled speed so that the copper foil 14 is immersed in the aqueous solution 18 for a required time as discussed below.

In the electrolytic cell 12, a power source (not shown) is provided so that a direct electric current may pass from the anodes 24 to the strip of copper foil (cathode) 14 by means of the electrolytic solution 22. In this way, an anti-tarnish coating with the desired composition and thickness is deposited on the foil strip 14.

The electrolytic solution 22 is an aqueous solution that consists essentially of a hydroxide source, zinc ion source and a water soluble hexavalent chromium. The hydroxide source is preferably sodium hydroxide or potassium hydroxide, and most preferably, sodium hydroxide (NaOH). The hexavalent chromium source may be any water soluble hexavalent chromium compound such as Na₂Cr₂O₇.2H₂O.

In its broadest compositional range, the electrolyte solution 22 consists essentially of from about 5 to about 100 grams per liter (g/l) of the hydroxide, from 0.07 up to about 7 g/l of zinc ions supplied in the form of a water soluble zinc compound such as ZnO, and from 0.01 to about 100 g/l of a water soluble hexavalent chromium salt. Provided, however, that at least one of the zinc ion or chromium (VI) ion concentrations is less than 1.0 g/l. In a preferred embodiment, the electrolyte contains from about 10 to about 40 g/l NaOH, from about 0.16 to about 2 g/l zinc ions, most preferably be in the form of 0.2 to about 1.6 g/l Zn ions and from about 0.08 to about 30 g/l Cr(VI) ions most preferably be in the form of from about 0.2 to about 0.9 g/l Cr(VI) ions.

With each of the electrolyte solutions 22 described herein above, it is believed that an effective concentration of a surfactant such as lauryl sulfate will provide a more uniform surface.

The pH of the electrolyte solution 22 is maintained as basic. A pH in the range of from about 12 to 14 is preferred. The electrolyte solution 22 readily operates at all temperatures from room temperature up to about 100° C. For maximum deposition rates, it is preferred to maintain the electrolyte solution 22 temperature in the range of about 35° C. to about 65° C.

The electrolyte solution 22 operates well in a wide range of current densities. Successful coatings may be applied with a current density ranging from 1 milliamp per square centimeter (mA/cm²) up to about 1 amp per square centimeter. A more preferred current density is from about 3 mA/cm² to about 100 mA/cm². The actual current density employed is dependent on the time the foil strip 14 is exposed to the current. That is, the time the copper foil strip 14 is between the anodes 24 and immersed in electrolyte solution 22. Typically, this dwell time is from about 10 to about 25 seconds. During this dwell, an effective thickness of the anti-tarnish coating compound is deposited. The effective thickness is that thickness capable of inhibiting copper tarnish at elevated temperatures of up to about 190° C. in air for about 30 minutes. The anti-tarnish coating should further be sufficiently thin to be easily removable with a 4% HCl etch solution or preferably a 5 wt % H₂SO₄ etch solution. It is believed that an effective coating thickness is from less than 100 angstroms to about 0.1 microns. Successful results have been obtained with coating thicknesses as low as 40 angstrom and coating thicknesses of from about 10 angstroms to about 100 angstroms are preferred. The coating layer is sufficiently thin to appear transparent or impart a slight gray tinge to the copper foil 14.

The coated strip of copper foil 14 exits the electrolytic cell 10 and is directed by rollers 28 through the aqueous solution 18 in the silane solution tank 16. The aqueous solution 18 preferably consists of at least 0.05% silane in DI (deionized) water at a temperature of between about 15° C. to about 30° C., and more preferably between about 20° C. to about 25° C. The copper foil 14 is preferably immersed in the aqueous solution 18 for one second or more.

The strip of copper foil 14 exits the silane solution tank 16, and any excess electrolyte solution 22 and aqueous solution 18 may be rinsed from the surfaces of the copper foil 14. The rinse solution may comprise deionized water. More preferably, a small quantity of a caustic is added to the deionized water rinse solution. The concentration of caustic is quite low, under 1 percent. Preferably the caustic concentration is from about 50 to about 150 parts per million. The caustic is selected to be the hydroxide of an alkali metal or the hydroxide of an alkaline earth metal selected from the group consisting of sodium hydroxide, calcium hydroxide, potassium hydroxide and ammonium hydroxide. Most preferred is calcium hydroxide.

After rinsing, the strip of copper foil 14 may be dried by forced air. The air may be cool (e.g., at room temperature) or heated. Heated forced air is preferred since accelerated drying minimizes spotting of the copper foil 14.

After drying, the copper foil 14 may then be bonded to a dielectric substrate for forming a printed circuit board or the like using any known lamination process. The dielectric substrate may include, for example, a fiberglass reinforced epoxy such as FR-4 (a fire retardant, glass filled epoxy) or a polyimide such as Kapton manufactured by DuPont. The lamination process may include bonding the copper foil layer to the dielectric substrate through the use of heat and pressure. For example, a pressure of about 300 psi, at a temperature at about 175° C. for a time of up to 30 minutes will provide suitable adhesion between the layers.

Surface Treatment 2

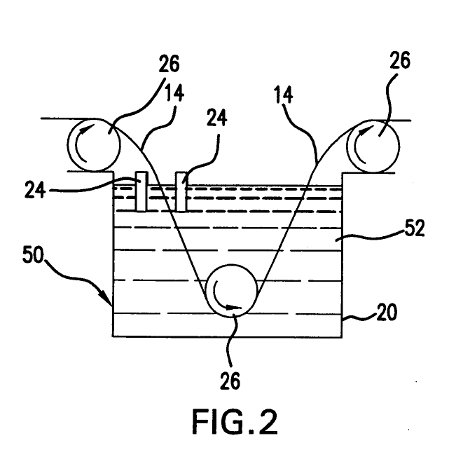

Referring now to FIG. 2, an electrolytic cell 50 for electrodepositing a peel strength enhancement coating on a copper foil, according to a second aspect of the present invention, is shown. The electrolytic cell 50 includes a tank 20 containing an aqueous electrolytic solution 52, and anodes 24 between which the strip of copper foil 14 passes. Guide rolls 26 may be used to control the travel of the strip of copper foil 14 through the electrolytic cell 50. The guide rolls 26 are manufactured from any material that does not react with electrolyte solution 52. Preferably, at least one of the guide rolls 26 is formed from an electrically conductive material, such as stainless steel, so that a current may be impressed in the strip of copper foil 14 as detailed below. Guide rolls 26 rotate at a controlled speed so that the copper foil 14 is positioned between anodes 24 for a required time as discussed below.

In the electrolytic cell 50, a power source (not shown) is provided so that an electric current may pass from the anodes 24 to the strip of copper foil (cathode) 14 by means of the electrolytic solution 52. In this way, a peel strength enhancement coating with the desired composition and thickness is deposited on the foil strip 14.

The electrolytic solution 52 is an aqueous solution containing polyatomic anions that contain oxygen (oxyanions) formed from a metal selected from groups 5B, 6B, and 7B of the periodic table of the elements. Preferably, the metal is selected from group 6B. Where the metal is capable of forming more than one oxyanion, the oxyanion containing the larger number of oxygen atoms is preferred (i.e., the “-ate” ion), and the oxyanion containing the largest number of oxygen atoms is most preferred (i.e., the “per______ate” ion). Group 5B includes vanadium, niobium, and tantalum. Group 6B includes chromium, molybdenum, and tungsten. Group 7B includes manganese, technetium, and rhenium.

In a preferred composition, the electrolytic solution 52 contains chromate, tungstate, or molybdate ions in DI water, and, for example, consists of about 1 to 200 g/l sodium dichromate. Optionally, about 5 to 100 g/l sodium sulfate or any other conductive salts can be added to increase the conductivity of the electrolyte. In a preferred embodiment, the electrolyte solution 52 consists essentially of about 5 to 75 g/l sodium dichromate.

The pH of the electrolyte solution 52 can be maintained in the range of about 0.5 to 14, preferably in the range of about 2 to 10, and most preferably in the range of about 4 to 9. The electrolyte solution 52 readily operates at all temperatures from room temperature up to about 100° C. For maximum deposition rates, it is preferred to maintain the electrolyte solution 52 temperature in the range of about 20° C. to about 80° C., and more preferably between about 40° C to about 60° C.

The electrolyte solution 52 operates well in a wide range of current densities. Successful coatings may be applied with a current density ranging from 5 amps per square foot (asf) up to about 200 asf. A more preferred current density is from about 10 asf to about 100 asf, and most preferably from about 30 asf to 70 asf The actual current density employed is dependent on the time the foil strip 14 is exposed to the current. That is, the time the copper foil strip 14 is between the anodes 24 and immersed in electrolyte solution 52. Preferably, this dwell time is about 2 seconds or more, and more preferably between about 5 to about 25 seconds. During this dwell time, an effective thickness of a peel strength enhancement coating comprising a metal and metal oxide mixture containing a metal selected from groups 5B, 6B, and 7B of the periodic table of the elements is deposited on the copper foil. When the peel strength enhancement coating is applied to smooth copper foil, the effective thickness is that thickness capable of providing less than or equal to 10% loss of peel strength, when measured in accordance with IPC-TM-650 Method 2.4.8.5 using a 1/8 inch wide test specimen, after being immersed in 4N HCl at about 60° C. for 6 hours. IPC-TM-650 is available from The Institute for Interconnecting and Packaging Electronic Circuits, 7380 N. Lincoln Avenue, Lincolnwood, Ill., 60646, and is described in further detail below. While the compositions of the treated surface have not been analyzed, it is believed the coating contains a mixture of metal and metal oxides with a thickness of about 20 to about 200 angstroms (Å). The morphology of the coating could also contain some micro-roughness to provide the adhesion enhancement effect.

The coated strip of copper foil 14 exits the electrolytic cell 50 and any excess electrolyte solution 52 may be rinsed from the surfaces of the copper foil 14. The rinse solution may comprise deionized water. More preferably, a small quantity of a caustic is added to the deionized water rinse solution. The concentration of caustic is quite low, under 1 percent. Preferably the caustic concentration is from about 50 to about 150 parts per million. The caustic is selected to be the hydroxide of an alkali metal or the hydroxide of an alkaline earth metal selected from the group consisting of sodium hydroxide, calcium hydroxide, potassium hydroxide and ammonium hydroxide. Most preferred is calcium hydroxide.

After rinsing, the strip of copper foil 14 may be dried by forced air. The air may be cool (e.g., at room temperature) or heated. Heated forced air is preferred since accelerated drying minimizes spotting of the copper foil 14.

After drying, the copper foil 14 may then be bonded to a dielectric substrate for forming a printed circuit board or the like using any known lamination process. The dielectric substrate may include, for example, a fiberglass reinforced epoxy such as FR-4 (a fire retardant, glass filled epoxy) or a polyimide such as Kapton manufactured by DuPont. The lamination process may include bonding the copper foil layer to the dielectric substrate through the use of heat and pressure. For example, a pressure of about 300 psi, at a temperature of about 180° C. for a time of approximately 30 minutes will provide suitable adhesion between the layers with FR-4. Polyimide would typically be laminated using a pressure of 425 psi, a temperature of 300° C. and a time of 2 minutes.

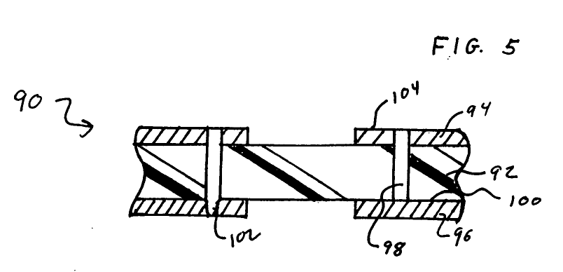

With reference to FIG. 5, in a typical printed circuit board 90, a dielectric layer 92 has first copper foil layer 94 and second copper foil layer 96 laminated to opposing sides thereof. Each foil layer has a thickness on the order of from 1.0 micron (0.00004 inch) to 5.1 microns (0.0002 inch) and a surface treatment as described above having an average surface roughness, R_{z}, of less than 1.0 μm and preferably, on the order of 0.4 μm to 0.8 μm. The surface treatment is deposited as a nodular structure with an average nodule height of less than 1.2 μm. Preferably, the average nodule height is from 0.3 μm to 1.0 μM. It is believed that the lower surface profile as compared to commercial thin copper foil products enhances stopping of the laser at a back side 100 of the second copper foil layer 96 during laser drilling. A minimum average surface roughness of about 0.4 μm is required for a suitable peel strength to prevent delamination of the copper foil.

Laser ablation approaches zero when the back side surface 100 has a reflectivity value of at least 40. Preferably, the reflectivity value is between 50 and 90. When the reflectivity value is less than 40, the laser penetrates the second copper foil layer 96. When the reflectivity value is in excess of 90, adhesion between the second copper foil layer and the dielectric layer 92 deteriorates.

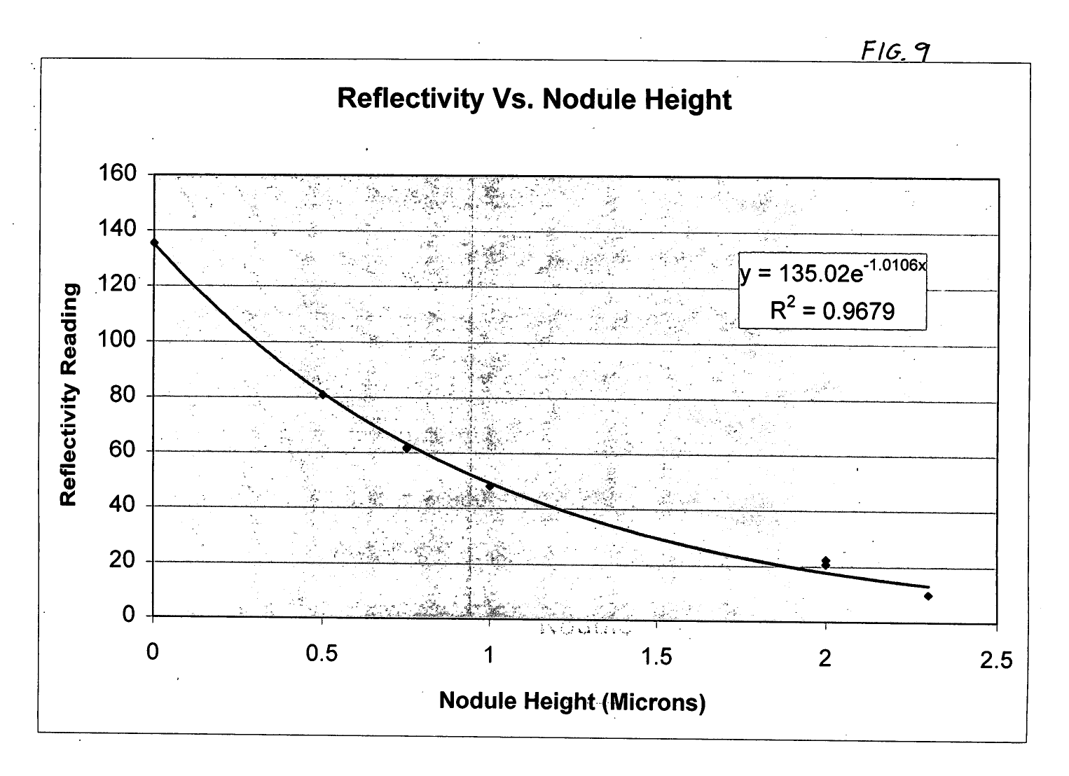

FIG. 9 graphically illustrates a correlation between the nodule height and the reflectivity value.

The copper foil layers 94,96 are formed into desired circuit traces, such as by photolithography. When electrical interconnection between opposing copper foil layers is required, a blind via 98 may be drilled through the first copper foil layer 94 and dielectric layer 92 to terminate at the back side 100 of the second copper foil layer 96. Typically, the blind via is drilled using multiple pulses from a CO₂ laser. These pulses, having an energy in the order of 300 microjoules (μj/pulse) deliver about 3 watts of power at a frequency of 10 kilohertz and complete a blind via in a fraction of a second.

The laser is intended to drill through the first copper foil layer 94 and dielectric 92, but not the second copper foil layer 96. If the laser pierces the second copper foil layer, a defect 102 may result. To enhance ablation of the first copper foil layer 94, a laser ablation enhancing layer, such as a dark oxide, may be formed on a surface 104 of the first copper foil layer 94 that is opposite the dielectric 92.

The advantages of the present invention will become apparent from the examples that follow. The following examples are intended to illustrate, but in no way limit the scope of the present invention.

### EXAMPLES

### Example 1

Various comparative and exemplary samples were created using copper foil laminated to an FR4 (glass filled epoxy) dielectric substrate. The copper foil, dielectric substrate, and lamination method used in each of the samples were the same. Different treatment methods were used on the copper foils for each of the samples. Each of the samples was first peel strength tested in accordance with IPC-TM-650 Method 2.4.8.5 using a 1/8 inch wide test specimen. Next, all but one of the samples were exposed to an 18% HCl solution at 25° C. for up to 48 hours and then peel strength tested again in accordance with IPC-TM-650 Method 2.4.8.5 to test the effect of hydrochloric acid (HCl), as may used during the PCB manufacturing process for cleaning of the laminated and photodefined printed circuit board (PCB). The results of these tests are provided in Table 1, which illustrates benefits of the present invention.

In general, IPC-TM-650 Method 2.4.8.5 describes a test to determine the peel strength of a conductor at ambient temperatures. The test specifies that the test specimen is a laminated copper foil free from such defects as delamination, wrinkles, blisters, cracks, and over-etching. The laminated specimen is imaged, then etched, cleaned, and processed using standard industry practices and equipment. As applied herein, the imaged line is 1/8 inch, and sheared samples with sanded edges are used. Each sample is prepared by peeling back the strip 1 inch so that the line of peel is perpendicular to the edge of the specimen. Each specimen is then secured against a horizontal surface, with the peeled metal strip projecting upward. The end of the strip is gripped between the jaws of a testing machine clamp, with the jaws covering the full width of the metal strip and parallel to the line of peel. A suitable testing machine is that which is commercially available from Carter Engineering Co., Yorba Linda, Calif. (Model # TA 520B10CR). A force is exerted in the vertical plane (90∓5°), and the metal foil is pulled at a rate of 2.0±0.1 inch-per-minute. The peel strength is determined as the average peel load in units of pounds per inch width.

Comparative sample 1 was manufactured using a copper foil having a rough, CopperBond® treated surface. Comparative sample 1 was also subjected to the P2 treatment described hereinabove, where a mixture of chromium and zinc ions or oxides was co-deposited on surfaces of the copper foil. Peel strength testing of comparative sample 1 revealed a peel strength of about 5.6 pounds per inch (lbs/inch). After 48 hours of exposure to the HCl solution, comparative sample 1 provided a peel strength of about 4.4 lbs/inch.

Comparative sample 2 was manufactured using a smooth copper foil subjected to the P2 treatment only. Peel strength testing of comparative sample 2 revealed a peel strength of about 1.6 lbs/inch. Comparative sample 2 delaminated (zero peel strength) after only 1 hour of exposure to the HCl solution.

Exemplary sample 3 was manufactured in accordance with the first aspect of the present invention. The smooth copper foil used in exemplary sample 3 was first given a P2 treatment and then dipped in a solution of 0.5% silane in DI (deionized) water at approximately 22° C. for one second or more. The sample was then rinsed in DI water and was dried prior to lamination. Peel strength testing of comparative sample 3 revealed a peel strength of about 5.5 lbs/inch. After 1 hour of exposure to the HCl solution, comparative sample 3 provided a peel strength of about 2.2 to 3.3 lbs/inch.

Comparative sample 4 was manufactured using a smooth copper foil subjected to a dip in a solution of 0.5% silane in DI (deionized) water at approximately 22° C. for one second or more. The sample was then rinsed in DI water and was dried prior to lamination. Peel strength testing of comparative sample 4 revealed a peel strength of about 1.5 lbs/inch.

Exemplary sample 5 was manufactured in accordance with the second aspect of the present invention, where a smooth copper foil was treated in a solution containing dichromate. Specifically, the solution contained 15 g/l sodium dichromate and 20 g/l sodium sulfate in DI water at cathodic 66 asf and 37° C. for 5 seconds or more. Following lamination to FR4 this treated foil had a peel strength of between 5.3 and 5.5 lbs/inch. After 48 hours of exposure to the HCl solution, comparative sample 1 provided a peel strength of about 3.0 to 3.6 lbs/inch.

TABLE 1
Effect of Surface Treatment on Peel Strength of Cu Foil

| | Treatment Applied | As-Laminated | | Peel Strength | |
|---|---|---|---|---|---|
| | to Smooth Cu | Peel | | Following HCl | |
| Sample Number | Surface | Strength | | Exposure | |
| 1 (comparative) | CopperBond ® treated + P2 | 5.6 | lb/inch | 4.4 | lb/inch (48 hr) |
| 2 (comparative) | P2 | 1.6 | lb/inch | 0.0 | lb/inch (1 hr) |
| 3 (exemplary) | P2 + Dip in 0.5% silane solution | 5.5 | lb/inch | 2.2-3.3 | lb/inch (1 hr) |
| | (First Aspect) | | | | |
| 4 (comparative) | Dip in 0.5% silane solution | 1.5 | lb/inch | — | |
| 5 (exemplary) | Electrodeposition in dichromate | 5.3-5.5 | lb/inch | 3.0-3.6 | lb/inch (48 hr) |
| | solution (Second Aspect) | | | | |

As can be seen in Table 1, exemplary samples 3 and 5 each provide a peel strength of about 5.5 lbs/inch, which is much greater than the peel strength provided by the surface treatments used in comparative samples 2 and 4, where only one of the P2 or the silane solution treatment was used. As also shown in Table 1, exemplary samples 3 and 5 provide a peel strength for smooth copper foil that is substantially equal to the 5.6 lbs/inch peel strength observed with a rough, CopperBond® treated foil. Thus, with the surface treatment methods of the present invention, smooth copper foil can have a peel strength substantially equal to that obtained using a conventional, rough-surfaced foil (e.g., a CopperBond® treated foil). This is especially advantageous when extreme fine circuit features or high frequency signal transmittance restricts the degree of surface roughness that may be used. Also, exemplary samples 3 and 5 also show the added benefit of maintaining a peel strength close to that obtained using the CopperBondg treatment, and substantially higher than that of P2 treatment alone, after exposure to HCl.

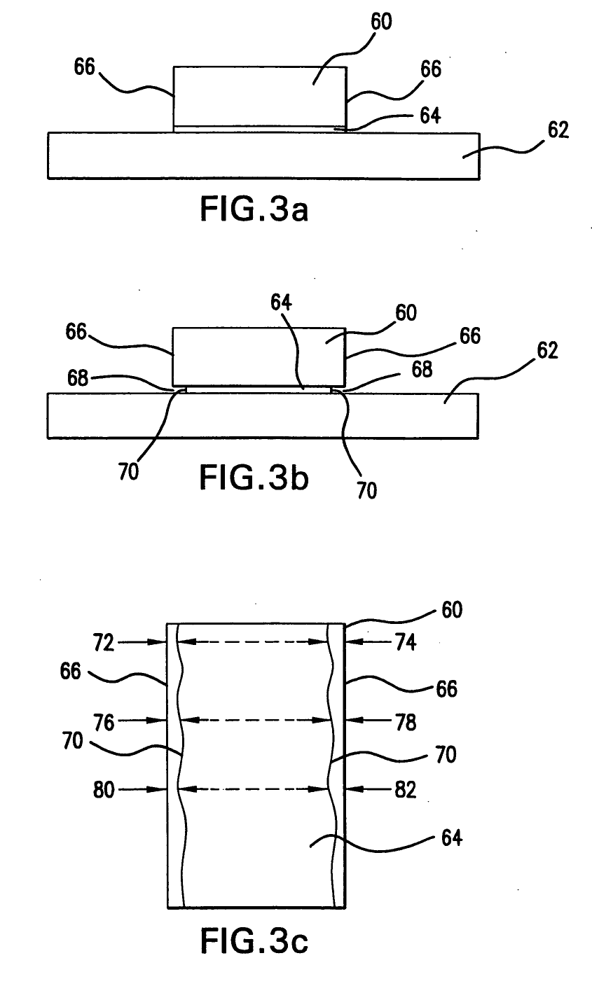

It was determined that peel strength loss due to HCl exposure is a function of the amount of coating material lost between the copper foil and the dielectric substrate caused by the HCl exposure. Such material loss is referred to herein as “edge undercut”, which can be explained by reference to FIG. 3. FIG. 3a is a cross-sectional view of a copper foil 60 laminated to a dielectric substrate 62 before exposure to HCl. Disposed between the copper foil 60 and the dielectric substrate 62 is a coating material 64, which may be a zinc or chromium-zinc (P2) anti-tarnish coating, or which may be a peel strength enhancement coating in accordance with the second aspect of the present invention. The copper foil 60 and coating material 64 form a portion of a photodefined electrical trace on the PCB. The thickness of the coating material 64 is exaggerated in FIG. 3 for purposes of explanation. Where coating material 64 is a peel strength enhancement coating, for example, the thickness of the coating material may be about 20 to about 200 Å.

As can be seen in FIG. 3a, before exposure to HCl, the coating material 64 extends substantially to the side surfaces 66 of the foil 60. Exposure to HCl, which would be used for cleaning the PCB, causes a portion 68 of the coating material 64 proximate the edge surfaces 66 to be removed (i.e., undercut), as shown in FIG. 3b. FIG. 3c is a lengthwise view of the strip of foil 60 revealing the undercut coating material 64. As can be seen in FIG. 3c, undercutting of the coating material 64 results in a non-linear edge 70 of the coating material 64.

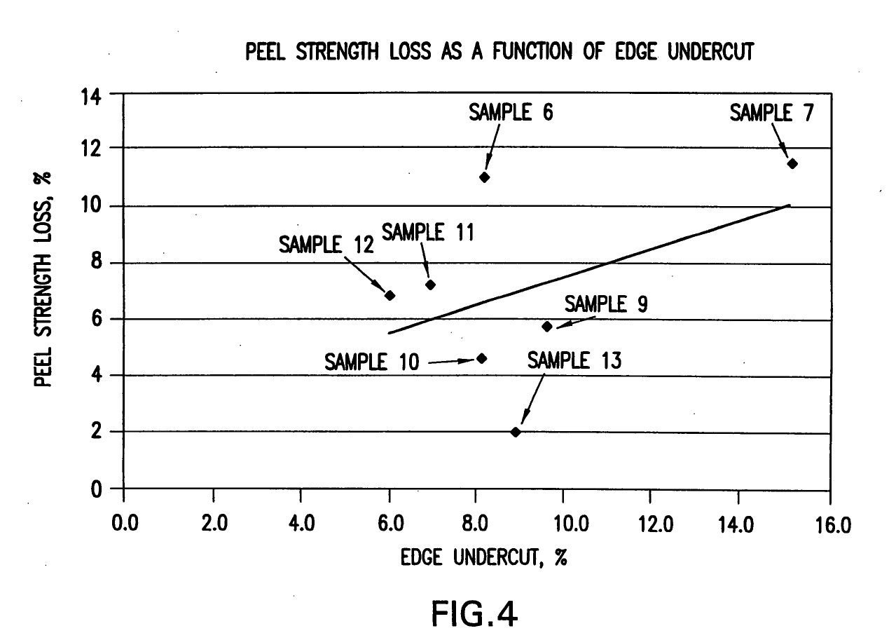

FIG. 4 is a curve-fit representation of data gathered from the testing of various comparative and exemplary samples created using copper foil laminated to an FR4 (glass filled epoxy) dielectric substrate and depicts peel strength loss (%) as a function of percent undercut.

As can be seen from FIG. 4, percent peel strength loss can be represented as a linear function of edge undercut. Thus, the more edge undercut experienced by the sample due to exposure to HCl, the greater the peel strength loss. With regard to the second aspect of the present invention (surface treatment 2), testing has shown that this treatment results in a reduction in both the percent edge undercut and the percent peel strength loss due to HCl exposure, when compared to prior art anti-tarnish coatings. This testing is described below.

Table 2 includes the data used to generate the graph of FIG. 4. The data of Table 2 were generated using a test method in which various comparative and exemplary laminate samples were created using smooth copper foils subjected to different surface treatments. Comparative samples 7-9 represent known surface treatments, while exemplary samples 9-14 represent surface treatments in accordance with the second aspect of the present invention (surface treatment 2). The copper foil, dielectric substrate, and lamination method used in each of the samples of Table 2 were the same, and the samples differed only by the surface treatment used.

For each sample in Table 2, the treated copper foil was laminated to an FR4 dielectric substrate (FR4 PCL 370 having a glass transition temperature (Tg) of 175° C.). The lamination cycle consisted of 50 minutes heating with a maximum temperature of 182° C. and a pressure of 300 psi followed by a 15 minute cooling cycle. The exposed surface of the copper foil was etched in a solution of ammonium persulfate (120 g/l ammonium persulfate plus 3% by volume of concentrated sulfuring acid (about 18 molar) in one liter of DI water) at 44° C. for 45 seconds. The sample was then rinsed and dried. Next, the copper foil was plated up to a thickness from about 0.0012 to 0.0016 inches using an acid copper bath without brighteners (60 g/l Cu and 65 g/l sulfuric acid in DI water at 50° C.). The desired thickness was obtained in 24 minutes using a current density of about 0.065 amps/cm². Using a guillotine paper cutter, 14 inch wide by 6 inch long test specimens were prepared from each sample, and each specimen was then sheared to 1/8 inch wide using a double edge precision shear. The edges of the specimens were lightly polished using a 600 grit paper to remove any damage that might be introduced by shearing.

At least four specimens were prepared for each sample. Half of the specimens (the control specimens) were peel strength tested in accordance with IPC-TM-650 Method 2.4.8.5 without being subjected to HCl. The “As-Laminated” peel strength for the sample is the average peel load for the control specimens in units of pounds per inch width. The remaining specimens were immersed in 4N HCl at 60° C. for 6 hours, followed by rinsing and drying. The exposed specimens were then peel strength tested in accordance with IPC-TM-650 Method 2.4.8.5. In Table 2, the “Peel Strength After 6 Hr HCl Exposure” is the average peel load for the exposed specimens in units of pounds per inch width. Also shown in Table 2 is the percent peel strength loss for each sample, which is equal to the peel strength after 6 hours of HCl exposure expressed as a percentage of the as-laminated peel strength.

The percent edge undercut for each sample was determined as follows. First, each exposed specimen was viewed under 100× magnification and the distance between the edge of the coating material to the edge of foil was measured on both sides of the exposed specimen at three different locations. Referring to FIG. 3, for example, these measurements are shown at 72, 74, 76, 78, 80, and 84, with three different measurements being made at each side 66 of the specimen. After the measurements were made, the average measurement for each side was calculated. The percent undercut for the specimen was then calculated as the sum of the average measurement for both sides expressed as a percentage of the total width of the specimen (1/8 inch). The percent edge undercut for the sample was then calculated by averaging the percent undercut for each specimen associated with the sample. The percent edge undercut for each sample is provided in Table 2.

TABLE 2
Effect of Surface Treatment on Peel Strength of Cu Foil

| | | | Peel Strength | | |
|---|---|---|---|---|---|
| | | As-Laminated | After 6 Hr HCl | % Peel | |
| | Treatment Applied to | Peel Strength | Exposure | Strength | |
| Sample Number | 5 μm Cu Foil | (lb/in) | (lb/in) | Loss | % Edge Undercut |
| 6 (comparative) | Commercial Surface | 4.56 | 4.05 | 11.2 | 8.2 |
| | Treatment | | | | |
| 7 (comparative) | P2 | 4.51 | 3.99 | 11.5 | 15.1 |
| 8 (comparative) | Zn—Ni | 4.14 | 3.32 | 19.8 | 22.0 |
| 9 (exemplary) | Chromate w/Si | 4.32 | 4.07 | 5.8 | 9.6 |
| 10 (exemplary) | Chromate | 4.52 | 4.31 | 4.7 | 8.1 |
| 11 (exemplary) | Thick Chromate (20 s) | 4.22 | 3.92 | 7.1 | 6.9 |
| 12 (exemplary) | Acidic Chromate | 3.88 | 3.62 | 6.7 | 6.0 |
| 13 (exemplary) | CDC | 4.64 | 4.55 | 1.9 | 8.9 |
| 14 (exemplary) | Tungstate | 4.29 | 4.32 | −0.7 | 7.2 |

Each of the samples in Table 2 was prepared using 5 μm copper foil. Comparative samples 6 and 7 were prepared using commercially available copper foils, with sample 7 being a P2 treated foil commercially available as XTF from Olin Corporation of Norwalk, Conn. Each of the comparative and exemplary samples 8-14 were prepared using commercial copper foil having the P2 removed and various surface treatments re-applied. The Zn—Ni coating of comparative sample 8 was deposited using an aqueous solution containing 10 g/l Ni as sulfate, 3 g/l Zn as sulfate, and 20 g/l citric acid at pH 4, 130° F., while applying 10 asf for 3 seconds and 50 asf for 3 seconds. The chromate with silicate coating of exemplary sample 9 was deposited using an aqueous solution containing 5 g/l Na₂Cr₂O₇. 2H₂O (1.75 g/l Cr), 10 g/l NaOH, and 10 g/l Na silicate at 140° F., while applying 20 asf for 10 seconds. The chromate coating of exemplary sample 10 was deposited using an aqueous solution containing 5 g/l Na₂Cr₂O₇. 2H₂O (1.75 g/l Cr), and 10 g/l NaOH, at 140° F., while applying 20 asf for 10 seconds. The thick chromate of exemplary sample 11 was deposited using the same aqueous solution as that of comparative sample 10, with an increased dwell time of 20 seconds. The acidic chromate of exemplary sample 12 was deposited using an aqueous solution containing 15 g/l Na₂Cr₂O₇. 2H₂O, and 20 g/l sodium sulfate at 104° F., while applying 66 asf for 10 seconds. The cathodic dichromate (CDC) of exemplary sample 13 was deposited using an aqueous solution containing 8.75 g/l Cr (25 g/l Na₂Cr₂O₇. 2H₂O) at pH 4, 140° F., while applying 40 asf for 5 seconds. The tungstate of exemplary sample 14 was deposited using an aqueous solution containing 31 g/l tungsten at pH4, 140° F., while applying 40 asf for 5 seconds.

As can be seen in Table 2, each comparative and exemplary provided an acceptable peel strength before exposure to HCl of about 4 lb/in. However, after exposure to HCl, the comparative samples showed a greater percent peel strength loss than did the exemplary samples. The comparative samples provided a percent peel strength loss in the range of 11.2 to 19.8 percent. The exemplary samples, on the other hand, were shown to be effective in providing a percent peel strength loss of less than or equal to 10 percent after being exposed to 4N HCl at 60° C. for 6 hours. Indeed, the exemplary samples were effective in providing a percent peel strength loss of less than or equal to about 7 percent. The exemplary samples also showed an improved resistance to edge undercut when compared to smooth foils having a P2 or Zn—Ni coating. It is believed that exposing the copper foil to silane prior to lamination, as in the first aspect of the present invention, would further enhance peel strength of copper foil treated in accordance with the second aspect of the present invention.

### Example 2

Copper foils as described in Table 3 were subjected to a single CO₂ pulse of about 300 μj/pulse. Foil A was a commercial product that was purchased from a vendor. Foil B was treated with P2 with an average surface roughness of 1.1 microns (R_{z}) as known from the prior art. Foil C was treated with P2 but with the average surface roughness reduced to 0.6 micron (R_{z}). Foil D was treated with the chromate of the invention.

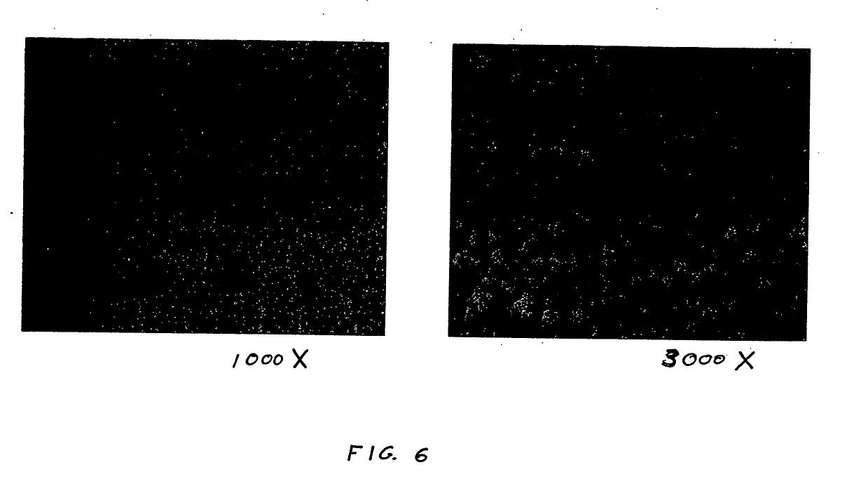

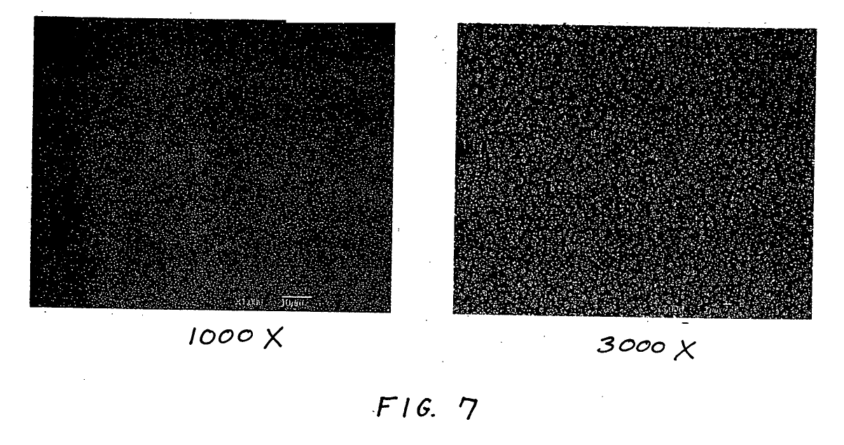

The surface morphology of control foil B is illustrated by a photomicrograph at magnifications of 1000× and 3000× in FIG. 6 and the surface morphology of inventive foil C is illustrated by a photomicrograph at magnifications of 1000× and 3000× in FIG. 7. The foils were also laminated to an FR-4 substrate and peel strength measured as described for Example 1.

TABLE 3
Laser Ablation

| | | | | | Peel | |
|---|---|---|---|---|---|---|
| | | | | | Strength | |
| | | R_{z}, Surface | Nodule Height | Area Ablated | (lb/inch) | |
| Foil | | Roughness (μm) | (μm) | (μm²) | FR-4 | Polyimide |
| A | Commercial | 1.5 | 2.0 | 1300 | 6.3 | |
| B | P2 | 1.1 | 2.5 | 2100 | 5.8 | 16.6 |
| C | P2 | 0.6 | 0.5 | -0- | 4.9 | 17.2 |
| D | Chromate | 0.6 | 0.5 | -0- | 4.5 | |

As can be seen from Table 3, the best combinations of resistance to laser ablation and highest peel strength were achieved by constraining the surface roughness and nodule height to nominals of 0.6 μm and 0.75 μm, respectively.

### Example 3

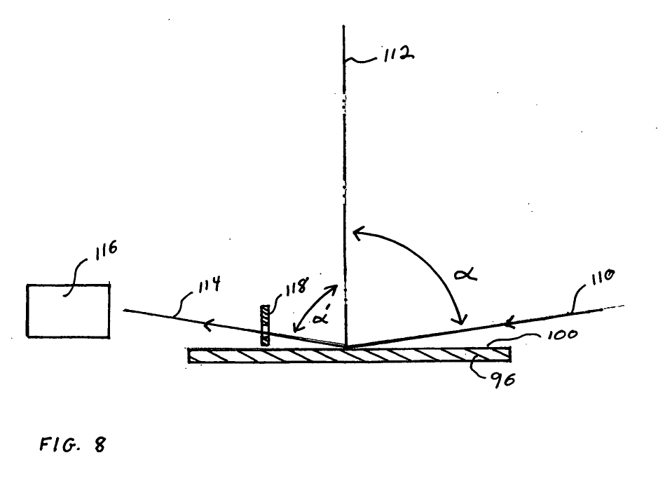

The reflectivity values of the copper foils of Table 3 were measured utilizing a DRLANGE Reflectometer RB type number LMG 064 (manufactured by Dr. Bruno Lange GmbH, Berlin, Germany). As shown in FIG. 8, a beam of light 110 was directed against the back side 100 of the second copper foil 96 at an angle α′ of 85° to an axis 112 normal to the second copper foil. In accordance with the law of reflection, the light beam is reflected 114 from the back side at the same angle α′ of 85°. The reflected light 114 is collected by detector 116. In addition to direct reflection, a certain amount of diffuse reflection is also present. This diffuse reflection is prevented from reaching the detector 116 by an aperture 118. For this Example 3, the light beam was oriented transverse to the rolling direction of the copper foil.

FIG. 9 presents the measured reflectivity values. As shown in FIG. 9, an excellent correlation exists between the reflectivity of the treatment surface and the nodule height. This is also indicative of how the laser ablatability is affected by nodule height.

| Foil | Reflectivity Value |
|---|---|
| A | 22 |
| B | 10 |
| C | 62 |
| D | 81 |

One or more aspects and embodiments of the present invention have been described. Nevertheless, it will be understood that various modifications may be made without departing from the spirit and scope of the invention. Accordingly, other aspects and embodiments are within the scope of the following claims.

What is claimed is:

1. A copper foil for lamination to a dielectric substrate, the copper foil comprising:
said copper foil being coated with a laser ablation inhibiting layer having an average reflectivity value of at least 40 that is effective to provide a lamination peel strength to FR-4 of at least 4.5 pounds per inch.

2. The copper foil of claim 1 wherein the average reflectivity value is between 50 and 90.

3. The copper foil of claim 1 wherein said laser ablation inhibiting layer comprises nodules having an average height of less than 1.2 microns.

4. The copper foil of claim 3 wherein said nodules have an average height of from 0.3 micron to 1.0 micron.

5. The copper foil of claim 2 wherein said laser ablation inhibiting layer is a codeposited mixture of chromium and zinc and their oxides.

6. The copper foil of claim 4 wherein said laser ablation inhibiting layer is a codeposited mixture of chromium and zinc and their oxides.

7. The copper foil of claim 2 wherein said laser ablation inhibiting layer is mixture of a metal and a metal oxide and said metal oxide is selected from the group consisting of oxides of chromium, tungsten and molybdenum.

8. The copper foil of claim 4 wherein said laser ablation inhibiting layer is mixture of a metal and a metal oxide and said metal oxide is selected from the group consisting of oxides of chromium, tungsten and molybdenum.

9. An electrically conductive circuit, comprising:
a dielectric substrate having opposing first and second sides;
a first copper foil layer laminated to a first side thereof, said copper foil coated with a laser ablation inhibiting layer having an average reflectivity value of at least 40 that is effective to provide a lamination peel strength to FR-4 of at least 4.5 pounds per inch;
said dielectric layer having a via extending therethrough and terminating at an interface between said dielectric layer and said first copper foil layer.

10. The electrically conductive circuit of claim 9 wherein the average reflectivity value of said laser ablation inhibiting layer is between 50 and 90.

11. The electrically conductive circuit of claim 10 wherein said laser ablation inhibiting layer comprises nodules having an average height of from 0.3 micron to 1.0 micron.

12. The copper foil of claim 11 wherein said laser ablation inhibiting layer is a codeposited mixture of chromium and zinc and their oxides.

13. The copper foil of claim 11 wherein said laser ablation inhibiting layer is mixture of a metal and a metal oxide and said metal oxide is selected from the group consisting of oxides of chromium, tungsten and molybdenum.

14. The copper foil of claim 11 wherein said dielectric substrate is selected from the group consisting of glass reinforced epoxy and polyimide.

15. A method for the manufacture of a printed circuit, comprising the steps of:
(a) coating a copper foil with a laser ablation inhibiting layer that is effective to provide a reflectivity value of at least 40 to said coated copper foil and that is effective to provide a lamination peel strength to FR-4 of at least 4.5 pounds per inch;
(b) laminating said at least a first layer of said coated copper foil to a first side of a dielectric substrate;
(c) forming said first layer into a plurality of circuit traces; and
(d) either before or after step (c) forming at least one via through said dielectric substrate to an interface with said first layer.

16. The method of claim 15 wherein said via is formed by laser ablation.

17. The method of claim 16 wherein said step (a) is effective to form said laser ablation inhibiting layer with an average surface roughness (R_{z}) of less than 1.0 μm and with nodules having an average height of from 0.3 micron to 1.0 micron.

18. The method of claim 17 including selecting said laser ablation inhibiting layer from the group consisting of a codeposited mixture of chromium, zinc and their oxides, and a mixture of a metal and a metal oxide where said metal oxide is selected from the group consisting of oxides of chromium, tungsten and molybdenum.

19. The method of claim 18 including depositing a laser ablation enhancing layer on a side of said copper foil opposite said interface.

20. The method of claim 18 including laminating a second layer of said coated copper foil to an opposing second side of a dielectric substrate, forming said second layer into a plurality of circuit traces and forming said at least one via through both second layer and said dielectric substrate to an interface with said first layer.
